(19) United States
(12) Patent Application Publication
(10) Pub. No.: US 2008/0027791 A1
(43) Pub. Date: Jan. 31, 2008

(54) SYSTEM AND METHOD FOR PROCESSING PERFORMANCE DATA

(76) Inventor: Robert K. Cooper, Ann Arbor, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/831,281

(22) Filed: Jul. 31, 2007

Related U.S. Application Data
(60) Provisional application No. 60/820,848, filed on Jul. 31, 2006.

(51) Int. Cl. G06F 11/34

(52) U.S. Cl. 705/11

(57) ABSTRACT

The present invention provides an improved system and method for processing performance data for an entity team, or individual. The system may further include a database for storing the performance data for an entity, team, or individual. The processing unit may be further configured to provide an output responsive to the performance data in the form of at least one progress parameter indicative of the amount and rate of progress toward completion of a work project or goal. The progress parameter may include a current rating; a cumulative rating; or a velocity rating, or a combination thereof.

### RELATED APPLICATIONS

This application claims the benefit of U.S. Provisional Patent Application No. 60/820,848 filed Jul. 31, 2006, hereby incorporated by reference in its entirety.

### BACKGROUND OF THE INVENTION

1. Field of the Invention

The present invention relates to a system and method for processing performance data, including a system and method for processing performance data for an entity, team, or individual.

2. Discussion of Related Art

Generally, because of the large number of data and statistics generated by the average business entity, most organizations must choose to focus on only a limited number of pieces of data and statistics. It is imperative that the limited number include those that are most important and provide the most value to the organization. This limited number of data and statistics must then be sufficiently available to those in the organization who need them to make informed decisions. Conventional systems may generally result in progress and objectives being measured and managed on the aggregate level and masking the importance of individual behaviors. Conventional systems may also measure only preexisting data, which does not encourage individuals to be innovative and collaborative in setting goals and objectives and taking affirmative steps to meet these goals and objectives.

Accordingly, there is a need for a system and method for processing performance data for an entity, team, or individual that will minimize and/or eliminate one or more of the above-identified deficiencies.

### SUMMARY OF THE INVENTION

The present invention provides a system and method for processing performance data for an entity team, or individual. The system may include a processing unit having an imputer interface configured to receive performance data for an entity, team, or individual. The system may further include a database for storing the performance data. The processing unit may have an output generator configured to provide an output, responsive to the performance data, including a progress parameter indicative of the amount and rate of progress toward completion of a work item (e.g., target) comprising one of work project or a work goal. The progress parameter may include one of a current progress rating; a cumulative progress rating; or a velocity progress rating.

The present invention is advantageous because it streamlines the collection, processing, and reporting of performance data for an entity, team, or individual. The present invention further facilitates analysis by providing visual representations of the performance data that enable users to quickly share and assess the data and determine the status of work projects or goals related to the data. The present invention may enable any number of users (e.g., a team of leaders, a department, a division, or an entire organization) to measure impact, not intentions, in innovation, teamwork, and key performance indicators on a daily, weekly, and/or monthly basis. The inventive system and method is designed to: (a) allow individuals to set their own areas for growth and/or contribution to an organization in order to avoid arbitrary goal assignments which do not lead to exceptional performance contributions and innovation, according to data; (b) Raise overall innovation-performance targets (i.e., financial targets, number of customers to be won, new products or services created and/or delivered to the marketplace, etc.); (c) Display all inputs and data in a one-click-access format; (d) Measure all leaders and colleagues every week in terms of contributions to these new results and innovations; and (e) Position the leaders of an organization to more effectively spread these higher-than-expected results and behaviors across the organization to increase and/or expand the overall success of the organization's mission or purpose.

These and other advantages and features of this invention will become apparent to one skilled in the art from the following detailed description.

### BRIEF DESCRIPTION OF THE DRAWINGS

FIG. 1 is a schematic of a system according to an embodiment of the invention.

FIG. 2 is a block diagram view of a system according to an embodiment of the invention.

FIG. 3 is a block diagram view showing, in greater detail, a processing unit of an embodiment of the invention.

FIG. 4 is an exemplary database structure in accordance with an embodiment of the invention.

FIG. 5 is an exemplary screen shot for the system in accordance with an embodiment of the invention.

FIG. 6 is a flow chart illustrating the step of inputting a work project or goal into the system in accordance with an embodiment of the invention.

FIG. 7 is a flow chart illustrating the step of updating a work project or goal in the system, for example, submitting a progress report, in accordance with an embodiment of the invention.

FIG. 8 is a flow chart illustrating the step of reviewing or modifying a work project or goal in the system, for example, rating a work project or goal, in accordance with an embodiment of the invention.

FIG. 9 is a flow chart illustrating the step of calculating a current rating in accordance with an embodiment of the invention.

FIG. 10 is a flow chart illustrating the step of calculating a cumulative rating in accordance with an embodiment of the invention.

FIG. 11 is a flow chart illustrating the step of calculating a velocity rating in accordance with an embodiment of the invention.

FIG. 12 is a flow chart illustrating the step of calculating a velocity rating in accordance with an embodiment of the invention.

FIG. 13 is a flow chart illustrating the step of displaying at least one parameter in accordance with an embodiment of the invention.

FIG. 14 is a table showing the data relating to a customers database in accordance with an embodiment of the invention.

FIG. 15 is a table showing the data relating to a users database in accordance with an embodiment of the invention.

### DETAILED DESCRIPTION

The present invention relates to a system and method for processing performance data for an entity, team, or individual. In an exemplary embodiment, the inventive system and method may comprise a web-based system that provides for the collection of performance data, processing of the performance data, determination of progress parameters, and display of visual representation of the progress parameters. The inventive system and method may allow for various levels of access to such data and visual representations to users based on security levels prescribed to each user.

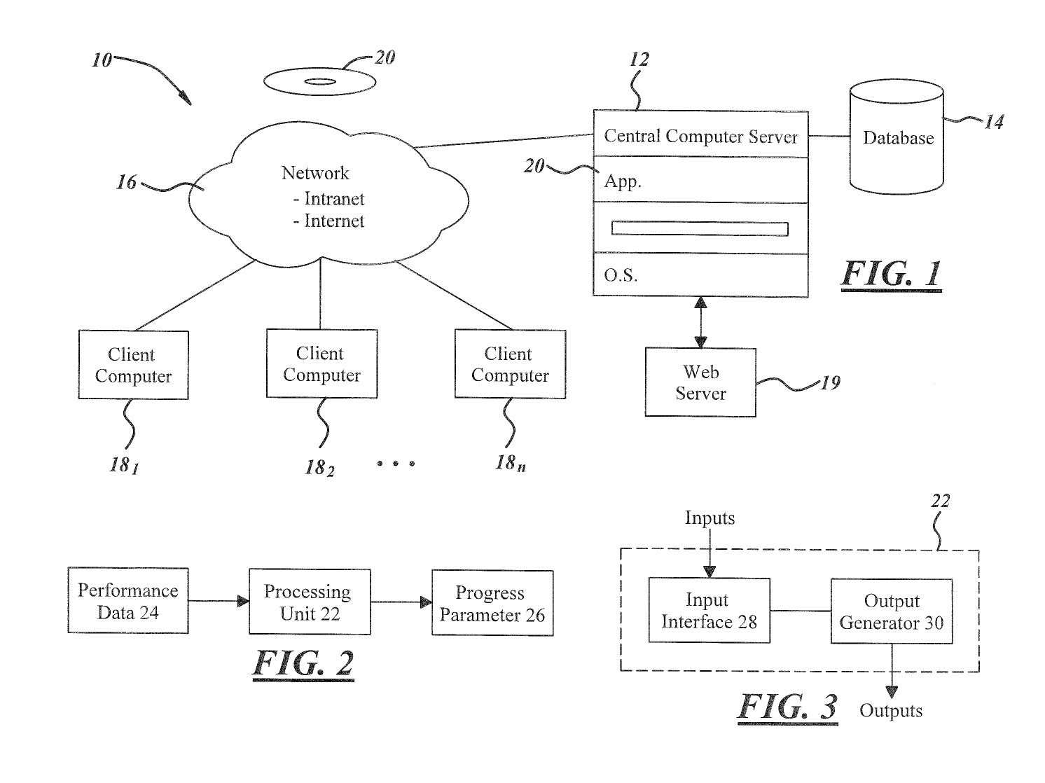

Referring now to the drawings in which the same reference numeral refers to identical components in the various views, FIG. 1 is a schematic of a system 10 in accordance with the present invention. In one embodiment, the present invention is contemplated as a central server computer 12 in communication with a database 14. While database 14 is shown separately, it need not be physically or logically separate from central computer 12. Central server computer 12 is in communication with a network 16. Network 16 is further in communication with a plurality of client computers 18₁₋ₙ at various facilities selected by the users of the inventive system. It should be understood by one of ordinary skill in the art that a client computer 18₁₋ₙ may comprise a computer, a personal digital assistant (“PDA”), or mobile device in communication with network 16 through an intranet or internet connection. Accordingly, a user may access system 10 through a web site at which the user may register and log onto the system 10. For example only, the client computers 18₁₋ₙ may be configured to include a web browser, and the central server 12 may be configured to include a web server 19, wherein individuals may access the inventive system 10 executing on computer 12 over the Internet.

The system 10 may further comprise software 20 which may include a computer program configured to operate in accordance with this enabling disclosure, including performance of the functions described herein. This software 20 may be configured to execute on an otherwise conventional hardware and software computing platform, such as a personal computer configured with various versions of the Windows operating system (e.g., Windows 2000, Windows XP), or Linux, or Unix, or various Apple Macintosh platforms. These conventional computing platforms are contemplated to include various underlying communication functionality. It should be appreciated that this is exemplary only and not limiting in nature. The foregoing applies to both central server computer 12 and client computers 18₁₋ₙ. It should be further understood that implementing the present invention in software, in conjunction with this enabling disclosure, would require no more than routine programming skills of one of only ordinary skill in the art.

In an embodiment, the main processing described herein occurs at the central computer 12, with various inputs obtained both locally (e.g., database 14), and remotely (e.g., performance data obtained by way of a client computer 18₁₋ₙ). In another embodiment, the performance data may also be input directly (locally) at the central computer 12 (e.g., a user at the facility where the central computer 12 is located). It should be understood by one of ordinary skill in the art that variations are possible in the particular distributed processing architecture chosen for any particular application.

As shown in FIG. 2, central computer 12 as described above may be configured to execute software 20 on a conventional computing platform (not shown). Central computer 12 as configured via software 20 includes a processing unit 22. Processing unit 22 may be configured to receive performance data 24 as an input. The processing unit 22 may be further configured to provide an output 26 in the form of a progress parameter or a visual representation of a progress parameter.

FIG. 3 is a block diagram view showing the processing unit 22 in greater detail which includes input interface 28 and output generator 30. Input interface 28 and output generator 30 may comprise a computer program configured to operate in accordance with the enabling disclosure to perform the described function. The computer program may be implemented in software, requiring no more than the routine programming skills of one of ordinary skill in the art, in connection with conventional hardware also known to those of ordinary skill in the art.

In an exemplary embodiment, users of system 10 may input performance data via input interface 28 to the processing unit 22 through an application provided on a website via central computer 12 that is accessible through a web browser on a remote client computer 18. In order to complete the application through a web browser, a user is given a user name and a password and directed to the correct website address. The user name and password define authorization credentials and are stored in database 14. At the website, the user may use the user name and password to gain access to the central computer 12, which is set up to provide to user (thus authenticated) the application. Once logged in, the user is directed to a home web page.

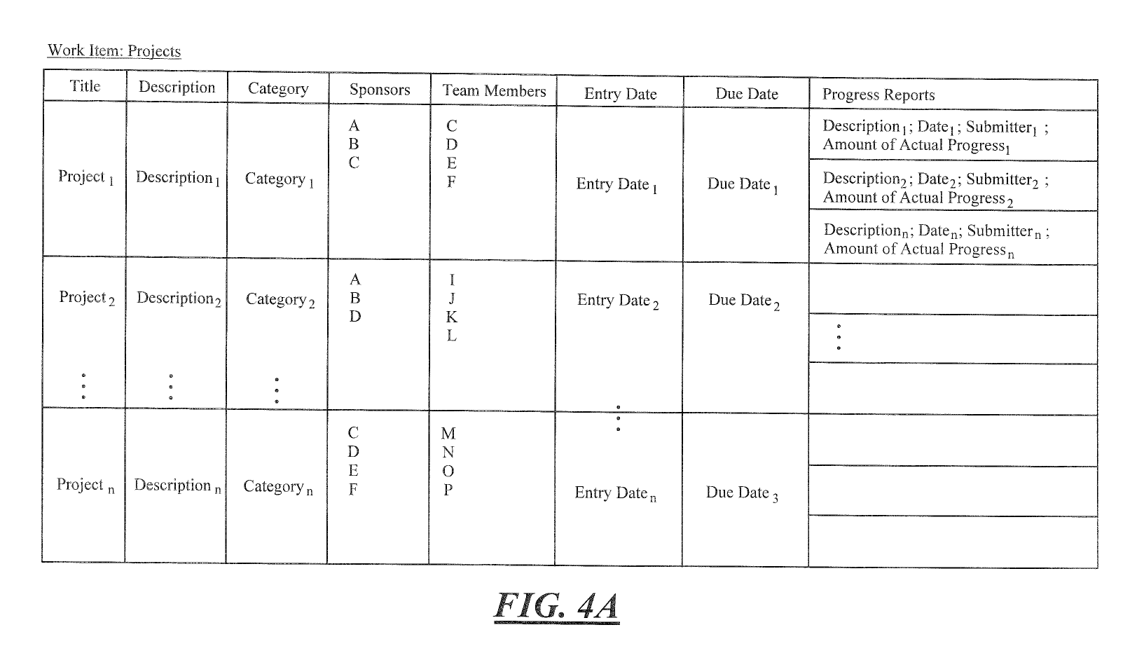

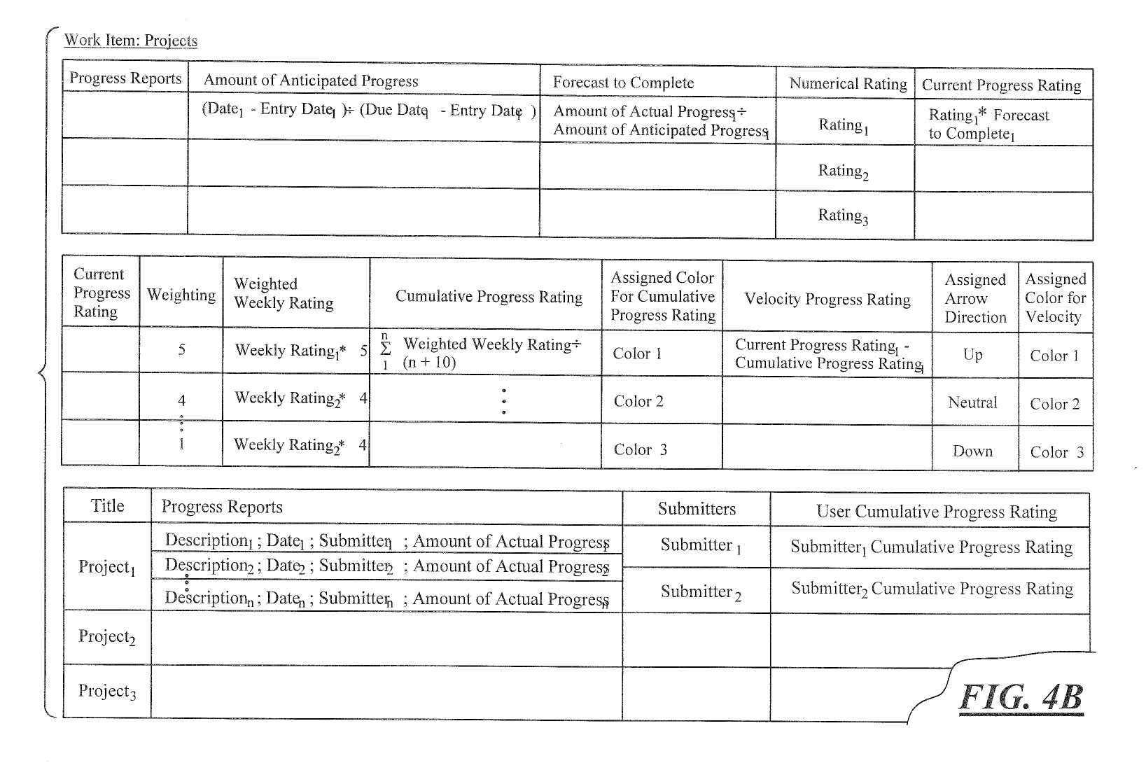

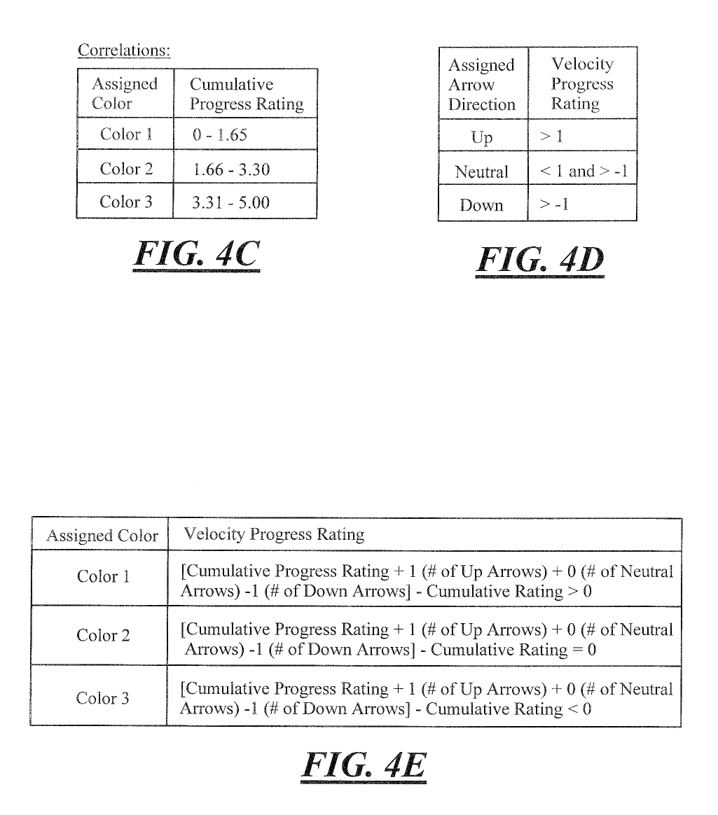

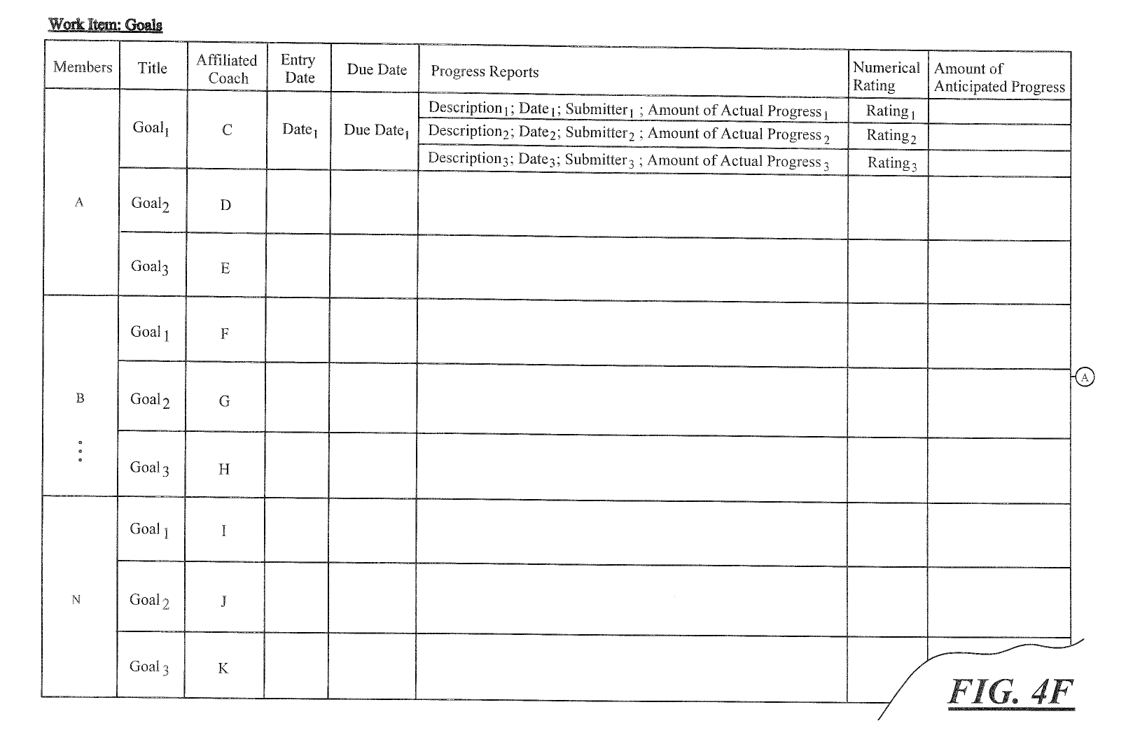

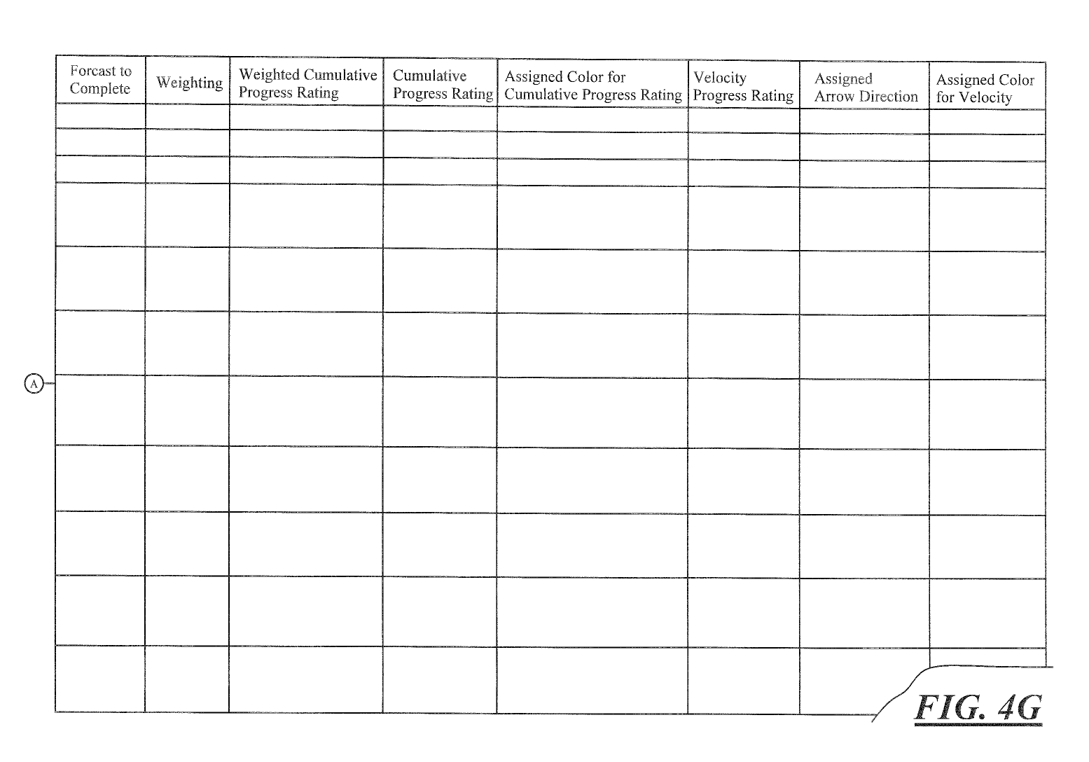

Referring now to FIG. 4, an exemplary structure for database 14 is illustrated. Database 14 may be configured to store input performance data 24, additional data that is generated based on performance data 24, calculated progress parameters 26, and data used to calculate progress parameters or for correlation with progress parameters, all for a plurality of work items (e.g., targets). A work item may comprise a work project or a work goal in an embodiment. It should be understood by those of ordinary skill in the art that a work project or work goal may apply to projects and goals for any organization, team, group, unit, or an individual, not merely projects and goals for a business or corporate entity. For a work project, database 14 may store input performance data 24, including a title, description, category, list of sponsors, list of team members, entry date, and due date for a work project. Database 14 may further store progress reports, including a description, date, submitter name, and amount of actual progress, as well as a numerical rating assigned to each progress report. It should be understood that each of the plurality of work projects may have a plurality of progress reports associated with it. Database 14 may store additional data that is generated based on performance data 24, including an amount of anticipated progress and a forecast to complete for at least the date corresponding to the date of each progress report. Database 14 may also store calculated progress parameters 26, including a current progress rating, a cumulative progress rating, and a velocity progress rating. Database 14 may further store data used to calculate progress parameters or for correlation with progress parameters, for example, weightings (e.g., weighting factors), colors to be assigned to cumulative progress ratings, arrow directions to be assigned to velocity progress ratings, and colors to be assigned to velocity progress ratings.

For a work goal, database 14 may store substantially similar information as for a work project. For example, for a work goal, database 14 may store member names and contact information, work goals associated with each member, and an entry date and due date for each goal. Database 14 may further store progress reports (e.g., including a description, date, and amount of actual progress, as well as a numerical rating assigned to each progress report). It should be understood that each of the plurality of work goals may have a plurality of progress reports associated with it. Database 14 may also store an amount of anticipated progress and a forecast to complete, a current progress rating, a cumulative progress rating, and a velocity rating for at least the date corresponding to the date of each progress report. Database 14 may further store weightings, colors to be assigned to cumulative progress ratings, arrow directions to be assigned to velocity progress ratings, and colors to be assigned to velocity progress ratings for the work goal.

Referring now to FIG. 5, an exemplary screen shot for system 10 displaying input performance data 24 and calculated progress parameters 26 (or data for correlation with progress parameters 26) is illustrated. FIG. 5 illustrates a title 32 for a work item (e.g., a work project), a description 34 for a progress report, a progress report date 36, a progress report submitter 38, and a numerical rating 40. The exemplary screen shot also displays visual indicators (e.g., representations) for the calculated progress parameters 26. In particular, the color associated with a calculated current progress rating is illustrated in a circular display 42. The color associated with a calculated cumulative progress rating is illustrated in a circular display 44. The velocity progress rating may be generally displayed as an arrow 46. Both the color and arrow direction associated with the calculated velocity progress rating is illustrated as arrow 46. A graphical representation of the calculated current progress rating over the lifetime of a work item may also be displayed in an embodiment. In another embodiment, a graphical representation of the calculated current progress rating over the lifetime of a work item for each member of a work project may also be displayed graphically. A substantially similar exemplary screen shot may be used in connection with a work goal.

Input interface 28 may be configured to receive performance data 24. Performance data 24 may be performance data for an entity, team, or an individual. Performance data 24 may include any of the following: a title for a work item, a description for a work item, a category for a work item, an entry date for a work item, or an estimated due date for a work item. Performance data 24 may further include the name of a sponsor, coach, or team member associated with a work item. Performance data 24 may further comprise a progress report description, a progress report date, an amount of actual progress, or a numerical rating assigned to a work item. In an embodiment, input interface 28 is configured to receive performance data 24 that is created (e.g., crafted or generated) by a user of system 10. Accordingly, performance data 24 that is input into input interface 28 may be data that is independently created by a user, rather than a business-generated metric, such as sales figures.

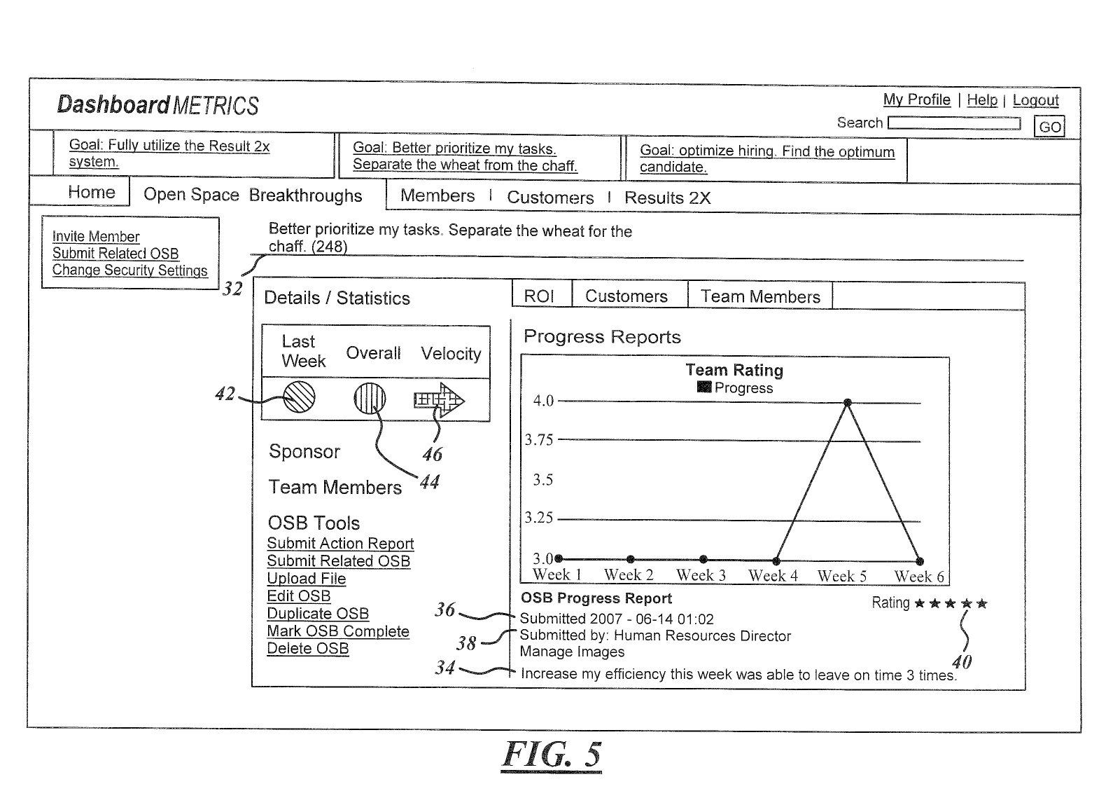

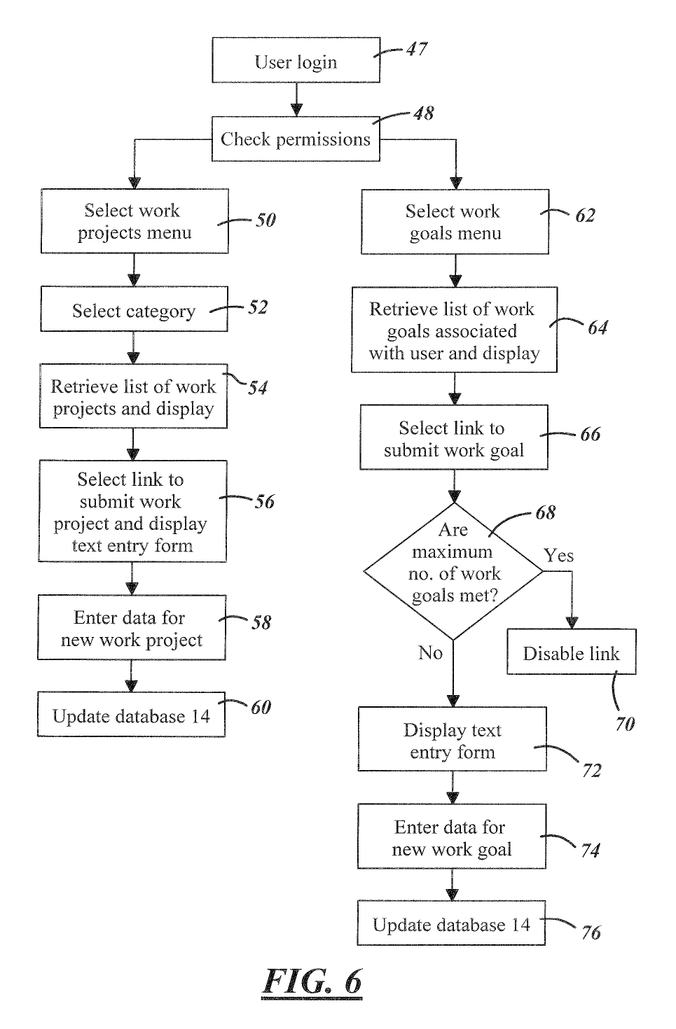

Referring now to FIG. 6, a flow chart for inputting performance data 24 into input interface 28 is illustrated. Following user login (step 47), the permission to view performance data previously input into the system is checked (step 48). The user is directed to a home page webpage that displays a total number of work items, a total number of work items for a time period (e.g., month), a total number of users (e.g., sponsors, coaches, team members), and a rate of company participation (e.g., the total number of users divided by the total number of employees). The homepage is configured to allow a user to select a menu (e.g., a hyperlink) to display a number of work items (step 50) which the user has permission to view and access. In an embodiment, the homepage of system 10 may be configured to allow all users of system 10 to view and access all work items input into system 10. In another embodiment, the homepage of system 10 may be configured to allow only certain users of system 10 to view and access all work items input into system 10. For example, system 10 may be configured to assign permissions to top executives and/or mentors at large for system 10 that may have a highest access to all work items input into system 10. System 10 may also be configured to allow for assignation of permissions to users to view and/or access only a select number of work items. System 10 may be configured to allow system users to have the ability to determine what permissions (e.g., posting, viewing, getting full access to details and progress for work projects and goals, editing, etc.) may be given to what users. Database 14 may store the permissions associated with each user of system 10.

Still referring to FIG. 6, the homepage of system 10 may be configured to allow a user to select a category for which a new work item (e.g., work project) to be input into the system relates (step 52). In an embodiment, a plurality such as fifteen categories of work projects may be displayed and accessible to a user. These categories may include, for example, All, Colleagues, Customers, Community, Company, and Core Performance. Although this number of and these names of categories are listed in detail, it is understood by those of ordinary skill in the art that more or fewer categories or various other types of categories may be chosen or selected to appear on a user's home webpage and remain within the spirit and scope of the invention.

After a user selects a category for which a new work project relates, this input is used by the system which is configured to retrieve the list of work projects and display them (step 54). Input interface 28 (e.g., the homepage) may be configured to allow a user to select a link to submit a new work project (e.g., a hyperlink entitled “Submit OSB”). The system may be configured to display a text entry form (e.g., template) to receive data (step 56). Data that is input by the user (step 58) that relates to a new work project (e.g., a title, detailed description, sponsors, team members, an entry date, and a due date associated with a work project) may be stored by database 14 and may be used by the system to generate various progress parameters. Database 14 is updated with the new work project and is associated with a particular category of work projects (step 60). In an alternative embodiment, the system may also be configured to receive input from a user regarding the category to which the work project may be assigned. The assigned category may be stored in database 14. In an embodiment, system 10 may be configured to allow a user to access a template for a current or past work project and revise the template. Data input in the revised template may also be stored by database 14 and may be used by the system to generate various progress parameters. A detailed description for a new work project may include an estimated return on investment for a period of time, potential new customers (e.g., including contact information), a policy statement relating to the work project, potential funding issues, anticipated results, potential intellectual property values, and information regarding current or future work projects that may be related to or linked to the current work project. System 10 may be configured to store the data relating to the new work project in database 14.

Alternatively to providing an interface to input data relating to a new work project, input interface 28 (e.g., the homepage) may be configured to allow a user to input data relating to a new work goal. System 10 may be configured to allow a user to select a menu (e.g., a hyperlink entitled “Results 2X™”) (step 62) after user login (step 47) and checking permissions (step 48) to view performance data previously input into system 10. Based on the user login, the system is configured to retrieve the list of work goals associated with the user and/or which the user has permission to view and/or access (step 64). The input interface may be configured to display a number of work goals which the user has permission to view and access. In an embodiment, system 10 may be configured to allow a user to be given permission only to view his or her own goals that he or she has input into system 10. Similarly, system 10 may be configured to allow multiple users to view a user's goals that have been input into system 10. Input interface 28 (e.g., the homepage) may be configured to allow a user to select a link (step 66) to submit a new work goal (e.g., a hyperlink entitled “Submit Goal”). The system may be configured to display a text entry form (e.g., template) to receive data. Data that is input by the user (step 74) that relates a new work goal (e.g., a title, a detailed description, sponsors, team members, an entry date, and a due date associated with a work goal) may be stored by database 14 (step 76) and may be used by the system to generate various progress parameters. The data stored in database 14 may be associated with a particular user or users. In an embodiment, system 10 may be configured to limit the number of new goals that may be input into system 10 to a predetermined data threshold (step 68). For example, in an embodiment, only three goals may be input into the system at a single point in time. This may encourage prioritization of goals. Although three is mentioned in detail as a predetermined data thresholds for new goals, it is understood by those of ordinary skill in the art that system 10 may be configured to allow for input of fewer or more goals and remain within the spirit and scope of the invention. If the predetermined data threshold is met, then the system may be configured to disable the link to submit a new work goal (step 70). If the predetermined data threshold is not met, then the system may be configured to make the link to submit a new goal active and display the text entry form (step 72).

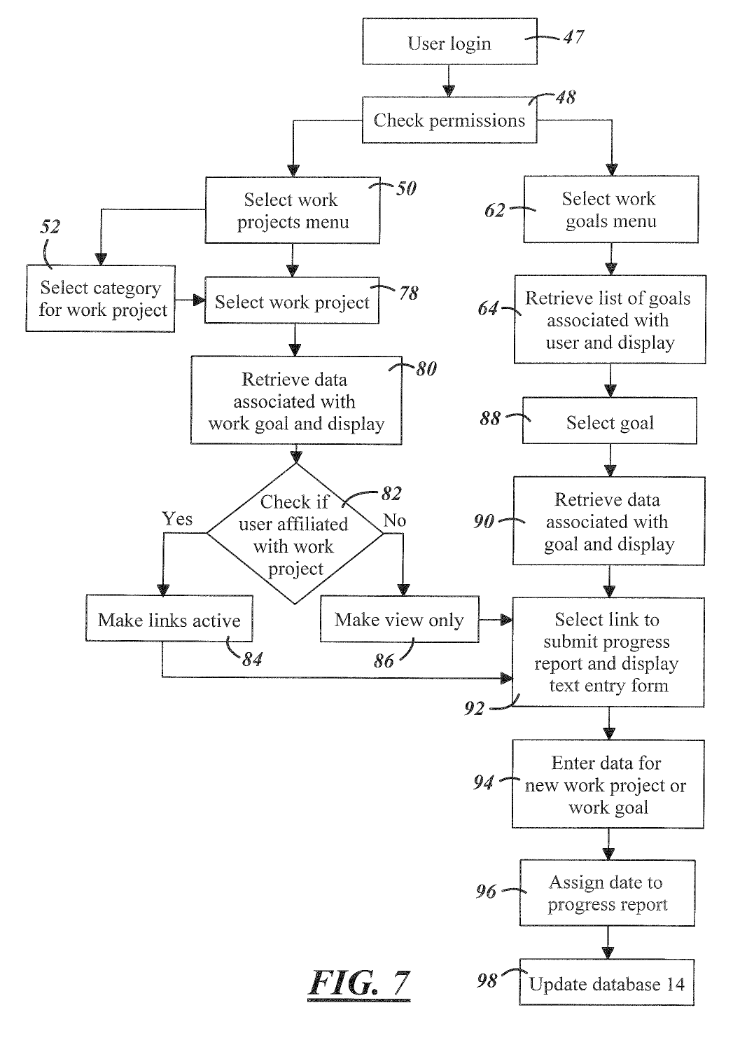

Referring now to FIG. 7, a flow chart for inputting additional performance data 24 into input interface 28 or updating performance data 24 stored in database 14 is illustrated. After a user selects a menu (step 50) to display a number of work items (e.g., work projects) which the user has permission to view and access, this input may be used by system 10 which is configured to retrieve the list of work items and display them. In another embodiment, the system may be configured to allow a user to select a category for a work project (step 52). The input interface (e.g., homepage) may be configured to allow a user to select a particular work item (step 78). In an embodiment, the system may be configured to provide that the title associated with a work item be accessible by a user of system 10 via a hyperlink. After a user selects a work item, this input is used by the system which is configured to retrieve the data associated with the work item that is stored in database 14 and display this data (step 80). System 10 may further be configured to display a link to submit a progress report. The system may be configured to check permissions (step 82), such that if the user is affiliated with the work item according to the permissions stored in database 14, then the link may be active (step 84). If the user is not affiliated with the work project according to the permissions stored in database 14, then the link may be view only (step 86). After the user selects the link to submit a progress report (e.g., a hyperlink entitled “Submit Action Report”), the system may be configured to display a text entry form (e.g., template) to receive data (step 92). Data that is input by the user (step 94) that relates to a new work item (e.g., a progress report description, a progress report date, an amount of actual progress, and/or a numerical rating assigned to the progress report) may be stored by database 14 (step 98) and may be used by the system to generate various progress parameters. System 10 may also be configured to assign a date (step 96) and the user's (e.g., submitter's) name to the progress report. Database 14 will also store this information. It is understood by those of ordinary skill in the art that the progress report may also be referred to as an action report in the description or drawings.

Alternatively to providing an interface to input data relating to an existing work project, input interface 28 may be configured to allow a user to input data relating to an existing work goal. Still referring to FIG. 7, system 10 may be configured to allow a user to select a menu (step 62) after user login (step 47) and checking permissions (step 48) to view performance data previously input into system 10. Based on the user login, the system is configured to retrieve the list of work goals associated with the user and/or which the user has permission to view and/or access and display them (step 64). The input interface (e.g., homepage) may be configured to allow a user to select a particular work goal (step 88). In an embodiment, the system may be configured to provide that the title associated with a work goal be accessible by a user of system 10 via a hyperlink. After a user selects a work goal, this input is used by the system which is configured to retrieve the data associated with the work goal that is stored in database 14 and display this data (step 90). System 10 may further be configured to display a link to submit a progress report. After the user selects the link to submit a progress report (e.g., a hyperlink entitled “Submit Action Report”), the system may be configured to display a text entry form (e.g., template) to receive data (step 92). Data that is input by the user (step 94) that relates to a new work goal (e.g., a progress report description, a progress report date, an amount of actual progress, and/or a numerical rating assigned to the progress report) may be stored by database 14 (step 98) and may be used by the system to generate various progress parameters. The progress report may generally relate to what specific action was taken in connection with a work project or goal and what specific progress was made with respect to a work project or goal. Entry data may include funding applications, return on investment, or customer growth to date. Entry data may also include, for example, specific accomplishments, energy increasers, time savers, improved prioritization, improved teamwork, cost reductions, new customer revenue, new customers, and breaking barriers. The system may be configured to be allow for entry of a progress report at any time by any user. In another embodiment, the system may be configured to allow for entry of a progress report at any time only by a user associated with a work goal as stored in database 14. System 10 may also be configured to assign a date (step 96) and the user's (e.g., submitter's) name to the progress report. In an embodiment, the system may be configured to permanently tag the progress report with the name and contact information for the submitter. Database 14 will also store this information. In an embodiment, system 10 may be configured to allow for entry of a progress report at any time. In another embodiment, system 10 may be configured to allow for entry of a progress report only at particular times (e.g., weekly). If the system is configured to only allow a progress report to be entered at a particular time (e.g., according to a schedule stored in database 14), and a user attempts to select the link to submit a progress report, system 10 may be configured to make the link to submit a progress report inactive.

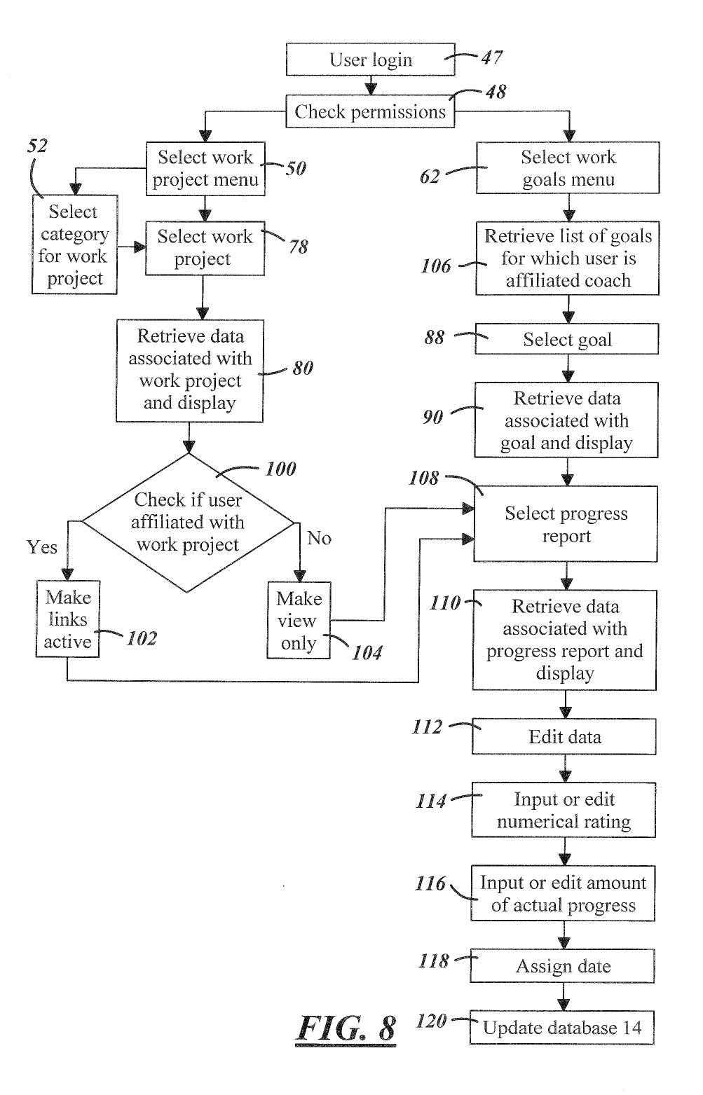

Referring now to FIG. 8, a flow chart for modifying performance data 24 stored in database 14 or inputting additional performance data into input interface 28 is illustrated. After a user selects a menu (step 50) to display a number of work items which the user has permission to view and access, this input is used by the system which is configured to retrieve the list of work items and display them. In another embodiment, the system may be configured to allow a user to select a category for a work project (step 52) prior to retrieving the list of work items associated with the category and displaying them. The input interface (e.g., homepage) may be configured to allow a user to select a particular work item (step 78). In an embodiment, the system may be configured to provide that the title associated with a work item be accessible by a user of system 10 via a hyperlink. In an embodiment, the system may be configured to include a link to expand the title into a complete description for a work item. After a user selects a work item, this input is used by the system which is configured to retrieve the data associated with the work item that is stored in database 14 and display this data (step 80). The system may be configured to allow data relating to whether another user (e.g., a coach) may have permission to delete a work item from the system (e.g., if the work item does not meet expectations for an entity, team, or individual). If the work item is deleted from the system by an authorized user, system 10 may removed data associated with the deleted work item from database 14.

System 10 may be configured to allow users to be given permission to indicate a work item is complete and delete it from the system. System 10 may be configured to provide a text entry form or template for a user to indicate that a work item is completed. In an embodiment, once a work item has been deemed completed, the system may be configured to prompt a user to generate a report in an embodiment. In another embodiment, system 10 may be configured to allow a user to indicate that a work item has been completed without prompting a report. Upon entry of a report and/or indication of completion, system 10 may be configured to maintain data relating to a work project visible and accessible, but disable links to further progress reports or allow for the entry of additional data. Upon entry of a report and/or indication of completion, system 10 may be configured to maintain data relating to a work goal visible and accessible, but no longer have the work goal constitute one of the limited number of work goals that may be input by a user of the system. For example, only a limited number goals may be input at a single time in order to encourage prioritization.

As indicated above, after a user selects a work item (step 78), this input is used by the system which is configured to retrieve the data associated with the work item that is stored in database 14 and display this data (step 80). The data associated with a work item may include all progress reports completed for a work item. The data associated with a progress report may include a progress report description, a progress report date, an amount of actual progress, and a numerical rating. The input interface (e.g., homepage) may be configured to allow a user to select a particular item of data associated with a progress report. In an embodiment, the system may be configured to provide that at least one item of data associated with the progress report be accessible by a user of system 10 via a hyperlink. After a user selects a particular item of data associated with the progress report (step 108), this input is used by the system which is configured to retrieve data currently associated with the progress report and display it in text entry form (step 110), if the user is affiliated with the work item according to the permissions stored in database 14 (steps 100, 102). For example, a coach (e.g., mentor) may be affiliated with all work items within a category and may therefore, have access to revise data associated with a item. If the user is not affiliated with work item according to the permissions in database 14, then system 10 is configured to make the link view only (steps 100, 104). The text entry form may also be configured to receive data. In an embodiment, the text entry form may b configured to allow the user to edit or assign data to the progress report. For example, the user may edit the description associated with the progress report (step 112), the user may input or edit a numerical rating associated with the progress report (step 114), and/or the user may edit or input the amount of actual progress associated with the progress report (step 116). In an embodiment, the numerical rating may range from 0.00 (e.g., no value) to 5.00 (e.g., exceptional value) and may include a visual indication of a number of stars. In an embodiment, half-stars may be utilized. It should be understood by those of ordinary skill in the art that a numerical rating may be assigned at any time following the entry of a progress report. Although these numbers and type of display are mentioned in detail, it is understood by those of ordinary skill in the art that any range of numerical rating (i.e., other than 0.00-5.00) and any type of visual display (i.e., other than stars) may be used and remain within the spirit and scope of the invention. The system may be configured to allow a numerical rating to be assigned by a user (e.g., coach) at any time. In an embodiment, the system may be configured to prompt user to input data on a weekly basis. Data that is input by the user may be stored in database 14 and may be used by the system to generate various progress parameters. The system may be configured to assign a date (step 118) and the user's (e.g., submitter's) name to the progress report. Database 14 will store this information and all data associated with the work item (step 120).

In addition to storing input performance data 24, database 14 may be further configured to store additional data that is generated based on performance data 24 and the algorithms that are used to generate the additional data. For example, processing unit 22 may generate an amount of anticipated progress for a work item. The amount of anticipated progress for a work item may be calculated using an algorithm that uses the entry date of a work item, an estimated due date for a work item, and a progress report date. In an embodiment, the amount of anticipated progress may be calculated (e.g., generated) by dividing the difference between the progress report date and the entry date of a work item by the difference between the estimated due date for a work item and the entry date of a work item. For another example, processing unit 22 may generate a forecast to complete. A forecast to complete may be calculated (e.g., generated) using an algorithm that uses the amount of progress and the amount of anticipated progress. In an embodiment, the forecast to complete may be calculated by dividing the amount of progress by the amount of anticipated progress.

Database 14 may be further configured to store calculated progress parameters and the algorithms that are used to generate (e.g., calculate) the progress parameters. Output generator 30 of system 10 may be configured to calculate and provide an output responsive to the performance data in the form of at least one progress parameter 26. The progress parameter 26 may be indicative of the amount and rate of progress toward completion of a work project or goal. The progress parameter may include a current progress rating, a cumulative progress rating, and/or a velocity progress rating. Current progress rating may also be referred to as a “Last Week rating” in the specification and drawings. This is because, for example, a current progress rating may be calculated every seven days (e.g., week).

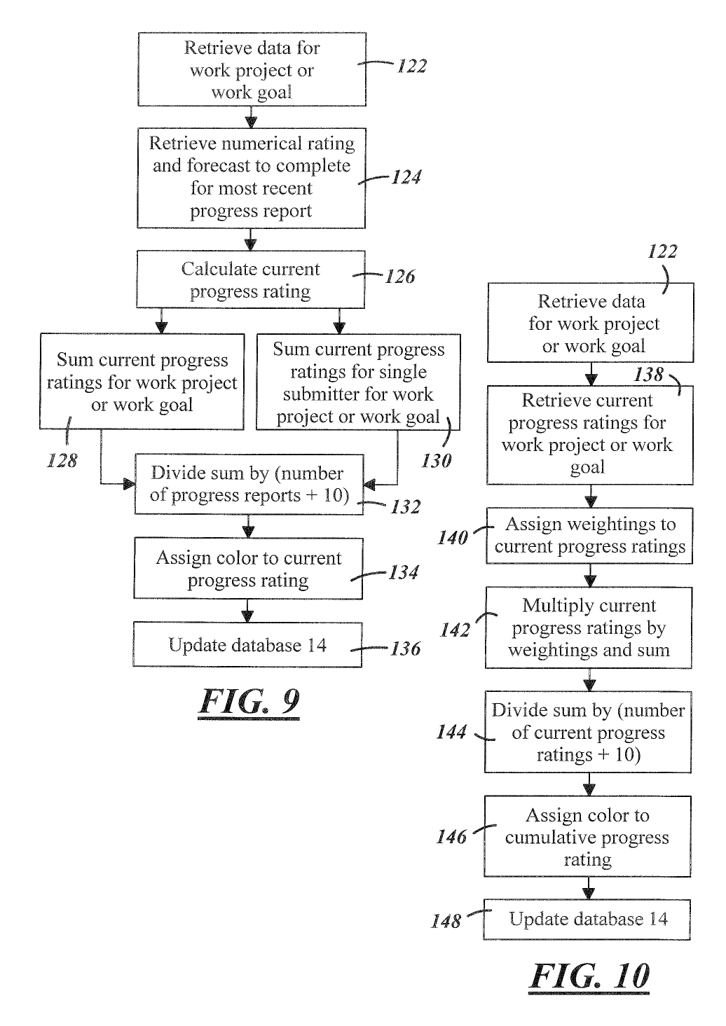

Referring now to FIG. 9, output generator 30 of system 10 may be configured to retrieve data for a work item (step 122) and retrieve the numerical rating assigned to a progress report for a work item with a progress report date that is within a predetermined period of time (e.g., 7 days for a weekly current progress rating); the amount of progress for each progress report for a work item with a progress report date that is within a predetermined period of time (e.g., 7 days for weekly current progress rating), the amount of anticipated progress for each progress report for a work item, the amount of progress for each progress report, and the forecast to complete that has been generated for each progress report (step 124). Output generator 30 may be further configured to calculate the current progress rating (step 126) by multiplying the numerical rating for a progress report by the forecast to complete. A current progress rating may therefore be associated with each progress report. In order to associate a current progress rating with an overall work item, the system may be configured to sum the current progress ratings associated with progress reports for a work item for a period of time (e.g., seven days) and divide by the total number of progress reports associated with a work item plus 10 (steps 128, 132). An average current progress rating may therefore be generated for a work item by system 10. In another embodiment, the system may be configured to sum the current progress ratings associated with progress reports for a work item for a period of time (e.g., seven days) for a particular user and divide by the total number of progress reports associated with a work item for a user plus 10 (steps 130, 132). An average current progress rating may therefore be generated for each user associated with a work item. All current progress ratings and/or average current progress rating may also be stored in database 14 (step 136).

Database 14 may further be configured to store data for correlation with progress parameters 26. For example, database 14 may store data relating to a visual indicator to be used in connection with a progress parameter. Data relating to a visual indicator to be used in connection with one or more progress parameters may be stored at a default setting in database 14. However, data relating to a visual indicator to be used in connection with one or more progress parameters may also be modified by an authorized user of the system. Data relating to a visual indicator to be used in connection with one or more progress parameters may be modified through input interface 28 and stored in database 14. For example, referring again to FIGS. 4 and 9, database 14 may store a first color for assignment to a first numerical range for the current progress rating. In an embodiment, the first color may be red, and the first numerical range may be approximately 0 to 1.65. Database 14 may store a second color for assignment to a second numerical range for the current progress rating. In an embodiment, the second color may be yellow, and the second numerical range may be approximately 1.66 to 3.30. Database 14 may store a third color for assignment to a third numerical range for the current progress rating. In an embodiment, the third color may be green, and the third numerical range may be approximately 3.31-5.00. Although these colors and numbers are mentioned in detail, it is understood by those of ordinary skill in the art that any number of colors and any number of numerical ranges may be utilized and remain within the spirit and scope of the invention. For example, the assigned colors may range from dark red and dark green on a spectrum with various shades in between. Dark red may indicate zero or a very low progress parameter, while dark green may indicate a high progress parameter. In other embodiments, a color associated with an organization (e.g., a color appearing on products, advertisements, etc.) may be indicative of a high progress parameter. In an embodiment, the color gray may be assigned to a progress parameter if no current data has been received to generate a current progress parameter within a predetermined period of time (e.g., seven days, if weekly progress reports are contemplated). Still referring to FIG. 9, the system may be configured to assign a color to the current progress rating (step 134) based on the value of the current progress rating and the data stored in database 14 that is indicative of the color correlation.

As set forth above, database 14 may be configured to store calculated progress parameters, the algorithms that are used to generate (e.g., calculate) the progress parameters, additional data that is generated based on performance data 24, the algorithms that are used to generate the additional data, and data for correlation with progress parameters 26. Data for correlation with progress parameters that may be stored in database 14 may include a weighting (e.g., weighting factor) to be assigned to a current progress rating. The weighting to be assigned to a current progress rating may depend on and be based on the time period (e.g., date) associated with the current progress rating. For example, the weight assigned to a more recent current rating may be greater than the weight assigned to a less recent current rating (i.e., the week before last has greater weighting importance than three weeks ago, etc.). For example, in a 10 week project or goal, the current rating for the tenth week may be given a weight of 5, the current rating for the ninth week may given a weight of 4, the current rating for the eighth week may be given a weight of 3, the current rating for the seventh week may be given a weight of 2, while the current rating for the first through sixth weeks may all be given a weight of 1 (e.g., no weighting). The use of the weighting scheme may allow a user to mitigate the impact of previous poor performance and may also prevent a user from coasting toward the end of a work project or goal.

Referring now to FIG. 10, output generator 30 of system 10 may be configured to retrieve data associated with a work item (step 122) and retrieve all current progress ratings for a work item since the entry date of the work item (step 138), as well as the weightings to be assigned to each current progress rating (step 140). Output generator 30 may be further configured to calculate the cumulative progress rating (step 142) by multiplying the weighting to be assigned to a current progress rating by the current progress rating, summing the products, and dividing by the total number of current progress ratings plus ten (step 144). All cumulative progress ratings may also be stored in database 14 (step 148). Database 14 may be configured to store data for correlation with progress parameters 26, including, for example, a visual indicator (e.g., color) to be assigned to a cumulative progress rating. The colors for assignment to numerical ranges for a cumulative progress rating may be the same as the colors for assignment to numerical ranges for a current progress rating as described above. However, it should be understood by those of ordinary skill in the art that any number of colors and/or numerical ranges may be utilized and remain within the spirit and scope of the invention. Still referring to FIG. 10, the system may be configured to assign a color to the cumulative progress rating (step 146) based on the value of the cumulative progress rating and the data stored in database 14 that is indicative of the color correlation.

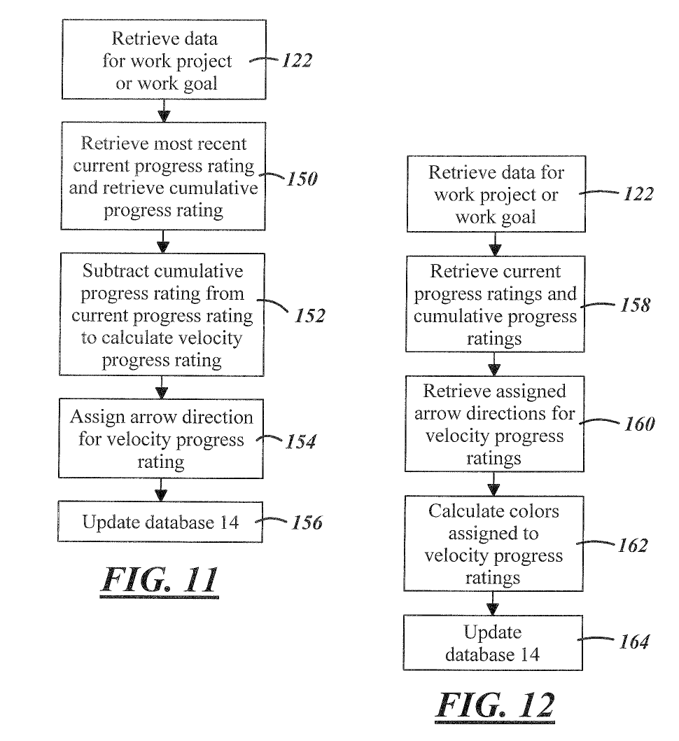

Referring now to FIG. 11, output generator 30 of system 10 may be configured to retrieve the most recent current progress rating for a work item and the most recent cumulative progress rating for a work item (step 150). Output generator 30 may be further configured to calculate the velocity progress rating by subtracting the cumulative progress rating at a date (e.g., the most recent date for which data is available in system 10) from the current progress rating at the same date (e.g., the most recent date for which data is available in system 10) (step 152). Database 14 may be configured to store all velocity progress ratings with a corresponding date (step 156). Database 14 may also be configured to store data for correlation with progress parameters 26, including, for example, a visual indicator (e.g., color and arrow direction) to be assigned to a velocity progress rating. Referring again to FIGS. 4 and 11, database 14 may store a first arrow direction for assignment to a first numerical range for the velocity rating. In an embodiment, the first arrow direction may be up, and the first numerical range may be greater than 1. Database 14 may store a second arrow direction for assignment to a second numerical range for the velocity rating. In an embodiment, the second arrow direction may be neutral (e.g., to the side), and the second numerical range may be less than 1 and/or greater than −1. Database 14 may store a third arrow direction for assignment to a third numerical range for velocity rating. In an embodiment, the third arrow direction may be down, and the third numerical range may be less than −1. Although these arrow directions and numerical ranges are mentioned in detail, it is understood by those or ordinary skill in the art that any number of arrow directions and any number of numerical ranges may be utilized and remain within the spirit and scope of the invention. For example, although database 14 may store data relating to the visual indicator to be used in connection with one or more progress parameters, (e.g., velocity rating) at a default setting, this default setting may be modified by an authorized user of the system (e.g., through input interface 28) and stored in database 14. Still referring to FIG. 11, the system may be configured to assign an arrow direction to the velocity progress rating (step 154) based on the value of the velocity progress rating and the data stored in database 14 that is indicative of the arrow direction correlation.

Database 14 may also be configured to store data relating to another visual indicator to be used in connection with the velocity progress rating. For example, a color may be associated with the velocity progress rating. In an embodiment, the color for assignment to the velocity progress rating may correlate with the color for assignment to the cumulative progress rating. In another embodiment, the color to be assigned to the velocity progress rating may be different than the color for assignment to the cumulative progress rating. Referring now to FIG. 12, processing unit 22 of system 10 may be configured to retrieve the current progress ratings (e.g., for the most recent date for which data is available in system 10), the cumulative progress rating (e.g., for the most recent date for which data is available in system 10), and the arrow directions assigned to each work item (steps 158, 160). Processing unit 22 of system 10 may be further configured to determine (e.g., correlate) the color to be assigned to the velocity progress rating by summing the cumulative rating plus (1 times the number of assigned up arrows) minus (1 times the number of assigned down arrows) plus (0 times the number of neutral arrows) (step 162). The processing unit of system 10 may be configured to assign a first color to the velocity progress rating if the calculation is greater than zero. In an embodiment, the first color may be green. The processing unit of system 10 may be configured to assign a second color to the velocity progress rating if the calculation equals zero. In an embodiment, the second color may be yellow. The processing unit of system 10 may be configured to assign a third color to the velocity progress rating if the calculation is less than zero. In an embodiment, the third color may be red. Again, it is understood by those of ordinary skill in the art that any number or various colors or numerical ranges may be used and remain within the spirit and scope of the invention. It should also be understood by those of ordinary skill in the art that modifications may be made to the algorithms or data relating to the generation of at least one progress parameter and remain within the spirit and scope of the invention. The system 10 may be configured to update database 14 with the color or colors to be assigned to the velocity progress rating (step 164).

The system may further include a display unit for displaying a visual indicator assigned to at least one progress parameter. For example, the display unit may be configured to display a color assigned to a current progress rating, a color assigned to a cumulative progress rating, and a color and an arrow direction assigned to a velocity progress rating.

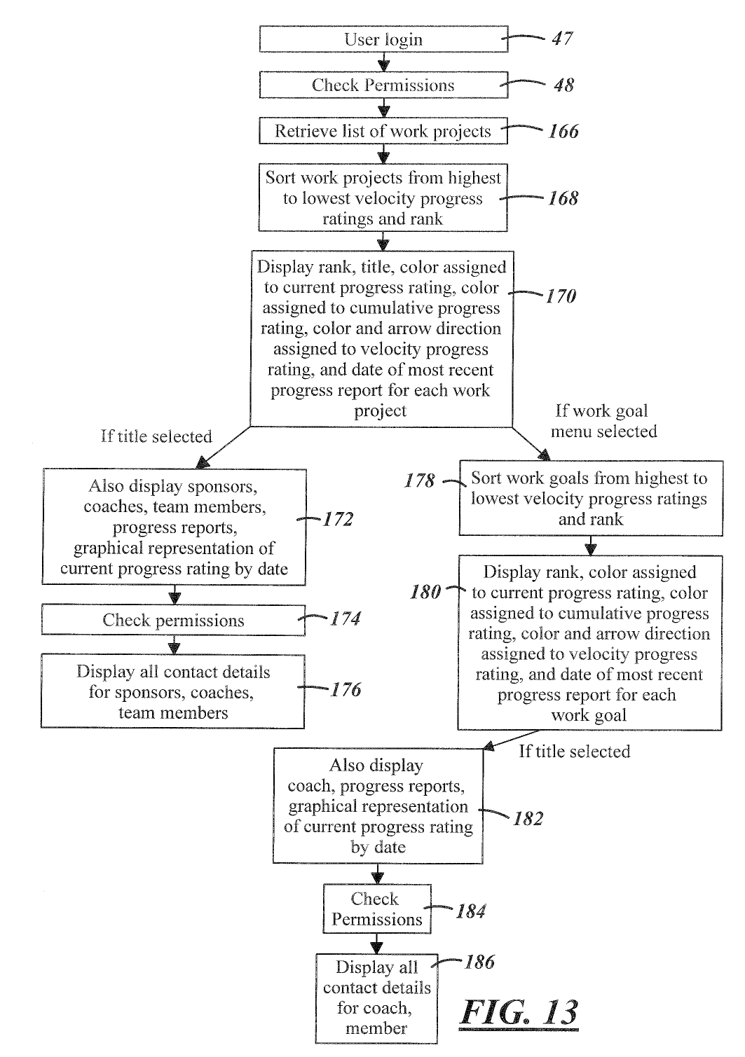

Referring now to FIG. 13, a flow chart illustrating the various data and parameters that may be displayed to a user of system 10 is shown. The system may be configured to retrieve (step 166) the following information after user login (step 47) and checking permissions (step 48): a list of work projects, the most recent current rating for each work project, the most recent cumulative rating for each work project, the most recent velocity rating for each work project, and the date of the most recent progress report for each work project. The system 10 may further be configured to sort the work projects (step 168) from the highest velocity rating to the lowest velocity rating and rank the work projects accordingly. The display unit of system 10 may be configured to display (step 170) the sorted work projects, including: the number of rank, the color assigned to the current progress rating, the color assigned to the cumulative progress rating, and the color and arrow direction assigned to the velocity progress rating. The display unit of system 10 may further be configured to display the title and date of the last progress report for each work project and an expandable tab (e.g., hyperlink) that may allow a user access to a more complete description for the work project. The display unit of system 10 may further be configured to retrieve and display: the total number of work projects, the total number of work projects for a time period (e.g., a month), the total number of users, and the company participation.

The display unit of system 10 is generally configured to display data in manner to allow further access to additional data through hyperlinks. For example, if a user selects a title (step 172) for a work project (e.g., a hyperlink entitled the title of a work project), the input is used by the system which is configured to retrieve the color assigned to the current progress rating for the work project, the color assigned to the cumulative progress rating for the work project, and the color and arrow direction assigned to the velocity progress rating and display them. In an embodiment, if the system determines that there is no current data affiliated with the work project (e.g., no data has been entered within a predetermined period of time (e.g., 7 days)), the system may be configured to display a visual indicator that indicates that there is no current data. For example, in an embodiment, the color gray may be assigned to the absence of data, such that if there is no data, a gray visual representation (e.g., indicator) may be used to enable a user to quickly learn that there is no current data. The system may also be configured to retrieve the data associated with each and every progress report (step 172) for the selected work project (including the text, entry date, numerical rating, amount of progress, and/or submitter name) and display it. The system may also be configured to retrieve data regarding the current progress rating over a period of time; generate a graphical representation of the current progress rating over a period of time (e.g., each week of the work project); and display the graphical representation. In one embodiment, the graphical representation may comprise an average current progress rating for a work project over a period of time, while in another embodiment, the graphical representation may comprise an average current progress rating for each member affiliated with a work project over a period of time in order to facilitate comparison between various team members working on single work project. System 10 may further be configured to retrieve and display the sponsors, team members, and coaches affiliated with the work project (step 172). In an embodiment, the names of the sponsors, team members, and coaches are hyperlinks (or may allow for further access by hovering over the name), so that the system 10 is configured to allow users to access contact information for each listed sponsor, team member, and coach, assuming that permission to view the contact information has been granted and is stored in database 14 (steps 174, 176).

If a user selects a menu (e.g., a hyperlink entitled Results 2X Menu) (step 178), this input is used by the display unit of system 10 which is configured to retrieve the list of work goals for which a user has either input the work goal or is designated as a coach according to database 14 and display them. The system is further configured to retrieve the most recent current progress rating assigned to the work goal, the most recent cumulative progress rating assigned to the work goal, and the most recent velocity progress rating assigned to the work goal. In addition, the date of the last progress report for each work goal may also be retrieved. The display unit of system 10 may be configured to sort the work goals from the highest velocity progress rating to the lowest velocity progress rating and rank the work goals accordingly (step 178). The display unit of system 10 may be configured to display the sorted work goals, including: the number of rank, the color assigned to the current progress rating, the color assigned to the cumulative progress rating, and the color and arrow direction assigned to the velocity progress rating (step 180). The display unit of system 10 may further be configured to display the title and date of the last progress report for each work goal and an expandable tab (e.g., hyperlink) that may allow a user access to a more complete description for the work goal. Generally, the most current progress parameters (e.g., current progress rating, cumulative progress rating, and velocity progress rating) will be retrieved and displayed. In an embodiment, if the system determines that there is no current data affiliated with the work goal (e.g., no data has been entered within a predetermined period of time (e.g., 7 days)), the system may be configured to display a visual indicator that indicates that there is no current data. For example, in an embodiment, the color gray may be assigned to the absence of data, such that if there is no data, a gray visual representation (e.g., indicator) may be used to enable a user to quickly learn that there is no current data. The system may also be configured to retrieve the data associated with each and every progress report (step 182) for the selected work goal (including the text, entry date, numerical rating, and/or amount of progress) and display it. The system may also be configured to retrieve data regarding the current progress rating over a period of time; generate a graphical representation of the current progress rating over a period of time (e.g., each week of the work goal); and display the graphical representation. System 10 may further be configured to retrieve and display the sponsors and coaches affiliated with the work goal (step 182). In an embodiment, the names of the sponsors and coaches are hyperlinks (or may allow for further access by hovering over the name), so that the system 10 is configured to allow users to access contact information for each listed sponsor and coach, assuming that permission to view the contact information has been granted and is stored in database 14 (steps 184, 186).

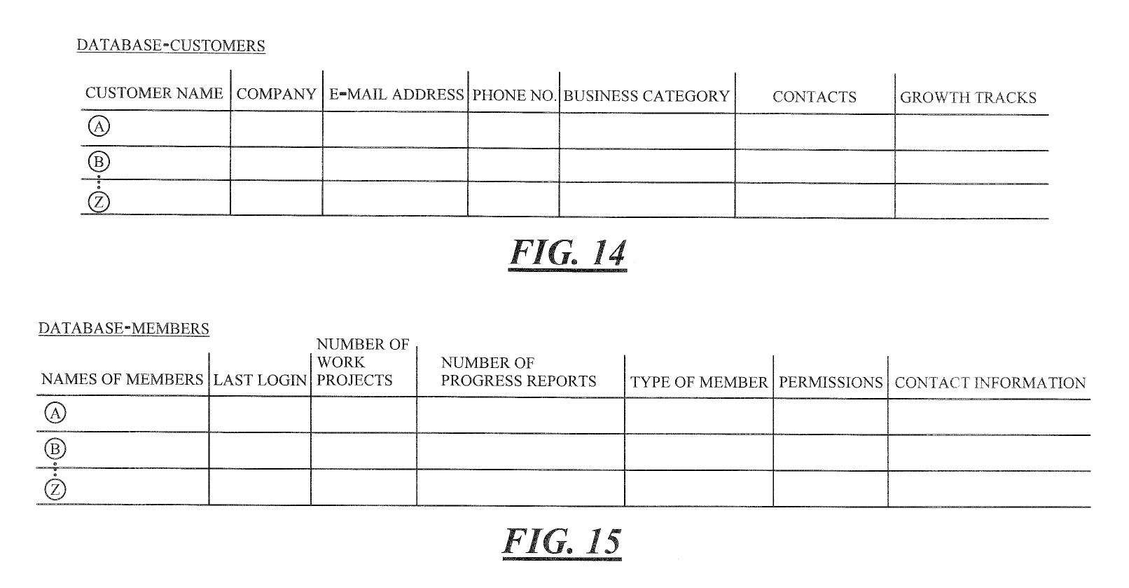

Database 14 may further be configured to store information relating to the customers of an entity, team, or individual. “Customer” may refer to any individual or organization the users of the system serve, work with (“current customer”), or wish to serve or work with (“target customer”). Referring now to FIG. 14, database 14 may store a customer's name, the company affiliated with the customer, contact information for the customer (e.g., e-mail address and phone number), a business category with which the customer is affiliated or associated, the name of the user within the entity or team with which the customer is affiliated or associated, the title or other identifying information of a work item to which the customer may potentially relate, and/or so-called growth tracks (e.g., title, identification number, company, contact, and description relating to areas for potential customer growth). This information may be input into system 10 through input interface 28. If a user selects a menu (e.g., a hyperlink entitled “Customers”), this input is used by the system which is configured to retrieve all or some of this stored data and display it. The Customers menu of system 10 may be configured so as to allow a user to view or search for customers. Various search strategies may be employed, e.g., a search for a particular customer or a search for customers within a selected category. System 10 is configured so as to display the retrieved customers, along with any information or data associated with the retrieved customers stored in database 14. In an embodiment, system 10 may be configured so as to allow all users access to view the customers of all other users. In another embodiment, system 10 may be configured so as to allow users only to access his or her own customers and/or customer with which he or she is affiliated. In another embodiment, system 10 may be configured so as to allow users to view only certain customers (e.g., target customers). New customers may be input into database 14 through input interface 28. Additional information regarding existing customers may also be input into database 14 through input interface 28. For example, if another user is interested in or is related to a customer already in the system, a user may input his or her name as another contact to be affiliated with or associated with the customer. System 10 may therefore allow for integrated, one-click customer connection.

Database 14 may further be configured to store information relating to the individual members of an entity or team. Referring now to FIG. 15, database 14 may store the names of members of system 10, the type of member (e.g., sponsor, coach, team member), the date of last login associated with each member, the number of work items (e.g., both work projects and work goals) associated with each member, the number of progress reports associated with each member, the permissions associated with each member (e.g., permissions of each member to view, access, and edit data), and contact information associated with each member (e.g., a profile). The profile may include name and contact information (e.g., first name, middle initial, last name, title, office address, city, postal code, country, time zone, work telephone, mobile phone, fax, e-mail, and best times to be reached). System 10 may be configured to provide for updating a profile through input interface 28. In one embodiment, users may assign the security settings (e.g., permissions) applied to each of the other users of system 10. If a user selects a menu (e.g., hyperlink entitled “Team Members”), this input is used by the system which is configured to retrieve all or some of this stored data and display it. The Team Members menu of system 10 may be configured so as to allow a user to view or search for users of system 10, including team members, coaches, and sponsors. If a user selects to view contact information for another user (e.g., by hovering over a name and/or clicking on a name), the system is configured to retrieve the permissions associated with the user. If the user has been granted permission, data relating to the selected user (e.g., contact information or other personal details) is displayed and/or accessible. For example, in an embodiment, only members of top management may be given permission to view data relating to other members of top management. In another embodiment, all data for all users may be viewable by all other users. Accordingly, the permissions or security settings applied to a member of system 10 may include the permission to view contact information other users, including permission to view contact information for various levels of personnel (e.g., upper echelon management, etc.). In addition, when information is displayed, if a user is authorized to view contact information, the contact information for each team member, sponsor, coach, etc. may be visible by hovering over or selecting (e.g., selecting the hyperlink associated with) the team member, sponsor, or coach.

A system and method for processing performance data in accordance with the present invention is advantageous. First, the system may integrate metrics and team and customer growth tracks. Second, the system may be based on a velocity-scale with visual representations that enables quick and efficient analysis and assessment of existing data to determine which business projects to pursue and where additional work and information is necessary. Third, the system may be accessed by any number of users from anywhere in the world at any time, and various levels of security access may be granted to any of various users to various parts of the system. Fourth, the system may help improve annual profit margin for users of the system. Fifth, the system may enable measurement of actual impact, rather than mere intentions.

While the invention has been particularly shown and described with reference to the exemplary embodiments thereof, it is well known by those skilled in the art that various changes and modifications can be made in the invention without departing from the spirit and scope of the invention.

1. A system for processing performance data for an entity, team, or individual, comprising:
(a) a processing unit having an input interface configured to receive performance data, wherein said performance data is generated by an individual;
(b) a database coupled to said processing unit configured to store said performance data;
(c) said processing unit further having an output generator configured to provide an output, responsive to said performance data, including a progress parameter indicative of the amount and rate of progress toward completion of a work item comprising one of a work project and work goal; said progress parameter including one of a current progress rating; a cumulative progress rating; or a velocity progress rating; and
(d) a display unit configured for displaying said performance data and a visual representation indicative of said progress parameter, wherein said display unit is further configured for displaying a visual representation indicative of the absence of performance data.

2. A system in accordance with claim 1, wherein said performance data comprises a title for the work item, a description for the work item, a category for the work item, an entry date for the work item, or an estimated due date for the work item.

3. A system in accordance with claim 1, wherein said performance data comprises the name of a sponsor, coach, or team member associated with the work item.

4. A system in accordance with claim 2, wherein said performance data comprises a progress report description, a progress report date, an amount of actual progress, or a numerical rating assigned to the work item.

5. A system in accordance with claim 1, wherein said progress parameter has a plurality of numerical ranges associated therewith, said database being further configured to store a first color associated with a first one of said plurality of numerical ranges.

6. A system in accordance with claim 5, wherein said database is further configured to store a second color associated with a second one of said plurality of numerical ranges.

7. A system in accordance with claim 6, wherein said database is further configured to store a third color associated with a third one of said plurality of numerical ranges.

8. A system in accordance with claim 4, wherein said database is further configured to store an amount of anticipated progress for the work item based on an entry date of the work item, an estimated due date for the work item, and a progress report date.

9. A system in accordance with claim 8, wherein said processing unit is configured to generate said current progress rating by multiplying a numerical rating assigned to the work item for at least one progress report date by the quotient of an amount of actual progress divided by the amount of anticipated progress.

10. A system in accordance with claim 9, wherein said database is further configured to store a weighting associated with said current progress rating.

11. A system in accordance with claim 10, wherein said weighting corresponds to a date associated with said current progress rating.

12. A system in accordance with claim 11, wherein said processing unit is configured to generate said cumulative progress rating by summing said current progress ratings over a time period extending from an entry date for the work item to a progress report date for the work item divided by the number of current rating plus 10.

13. A system in accordance with claim 12, wherein said processing unit is configured to generate said velocity progress rating by subtracting said cumulative progress rating from said current progress rating.

14. A system in accordance with claim 13, wherein said velocity progress rating has a plurality of numerical ranges associated therewith, said database being further configured to store a first arrow indication associated with a first one of said plurality of numerical ranges of said velocity progress rating.

15. A system in accordance with claim 14, wherein said database is further configured to store a second arrow indication assigned to a second one of said numerical ranges of said velocity progress rating.

16. A system in accordance with claim 15, wherein said database is further configured to store a third arrow indication assigned to a third one of said numerical ranges of said velocity progress rating.

17. A system in accordance with claim 12, wherein said database is further configured to store a color for association with or assignment to said velocity progress rating.

18. A system in accordance with claim 1, wherein said database is further configured to store contact information for users of said system.

19. A system in accordance with claim 18, wherein said database is further configured to store whether a user of said system is authorized to view said contact information.

20. A system in accordance with claim 19, wherein if a user is authorized to view said contact information, said contact information is visible by hovering over or selecting information displayed to a user of said system.

21. A system in accordance with claim 1, wherein said display unit is configured to display a color assigned to said current progress rating, a color assigned to said cumulative progress rating, and a color and arrow direction assigned to said velocity progress rating.

22. A computer-implemented method for assessing and displaying performance data for an entity or individual, the method comprising:
inputting performance data for an entity, team, or individual relating to a work item, the work item comprising a work project or a work goal;
storing said performance data;
displaying said performance data;
inputting at least one progress report relating to said performance data;
assigning a rating to said at least one progress report;
calculating at least one progress parameter indicative of the amount and rate of progress toward completion of the work item, said progress parameter including a current rating, a cumulative rating, or a velocity rating, or a combination thereof;
assigning a visual representation to said at least one progress parameter at a predetermined period of time; and
displaying said visual representation at said predetermined period of time.

23. A method in accordance with claim 22, wherein said performance data is displayed in a manner configured to allow further access to additional data through hyperlinks.

24. A method in accordance with claim 22, wherein said performance data is assigned to one of a plurality of categories.

25. A method in accordance with claim 22, further comprising displaying a visual indicator that there is no current performance data.

26. A method in accordance with claim 22, further comprising limiting the amount of performance data that may be input to a predetermined data threshold.

27. A system for processing performance data for an entity, team, or individual, comprising:
a processing unit having an input interface configured to receive performance data for an entity, team, or individual, said performance data comprising information relating to a work item including an entry date for the work item and an estimated due date for the work item;
said input interface further configured to receive additional performance data relating to the work item, including a progress report and a numerical rating assigned to the progress report;
a database coupled to said processing unit configured to store said performance data;
said processing unit further having an output generator configured to provide an output, responsive to said performance data, including a progress parameter indicative of the amount and rate of progress toward completion of the work item, said progress parameter including one of a current progress rating based on the numerical rating assigned to the progress report; a cumulative progress rating based on the current progress ratings since the entry date for the work item each multiplied by a weighting; or a velocity progress rating based on the difference between the current progress rating and the cumulative progress rating;
wherein said progress parameter has a plurality of numerical ranges associated therewith, said database being further configured to store a first color associated with a first one of said plurality of numerical ranges, a second color associated with a second one of said plurality of numerical ranges, and a third color associated with a third one of said plurality of numerical ranges;
and a display unit for displaying said performance data and for displaying a color associated with said progress parameter.
